(19) United States
(12) Patent Application Publication
(10) Pub. No.: US 2026/0365277 A1
(43) Pub. Date: Nov. 19, 2026

(54) Drive Unit for a Vehicle

(71) Applicant: ZF Friedrichshafen AG, Friedrichshafen (DE)

(72) Inventors: Kevin Holder, Meckenbeuren (DE); Oliver Löchte, Wangen (DE); Thomas Merath, Meckenbeuren (DE)

(21) Appl. No.: 19/102,118

(22) PCT Filed: Aug. 4, 2023
(86) PCT No.: PCT/EP2023/071682

§ 371 Date: Feb. 7, 2025

(30) Foreign Application Priority Data
Aug. 9, 2022 (DE) 102022208264.8

(51) Int. Cl. B62M 6/55

(52) U.S. Cl. CPC B62M 6/55

(57) ABSTRACT

A propulsion device for a vehicle has an electric motor (3, 4) for at least intermittently propelling the vehicle, a crank axle (2) for receiving muscle power to at least intermittently propel the vehicle by muscle power, and an output element (14) via which the propulsive force for propelling the vehicle output from the propulsion device. A gearing having a predetermined transmission ratio is provided is coupled on the input side to an output element (5) of the electric motor (3, 4) and is couplable on the output side to the output element (14) of the propulsion device via a gearing output element (9). A crank axle output element (12) is coupled to the crank axle (2) and couplable to the output element (14) of the propulsion device. A torque limiting assembly (20) configured to limit a torque acting on a rotor (3) of the electric motor.

### CROSS-REFERENCE TO RELATED APPLICATIONS

The present application is related and has right of priority to German Patent Application No. DE 102022208264.8 filed on Aug. 9, 2022 and to PCT Application No.

PCT/EP 2023/071682 filed on Aug. 4, 2023, both of which are incorporated by reference in their entireties for all purposes.

### TECHNICAL FIELD

The present invention relates generally to a propulsion device for a vehicle which is propelled at least intermittently by an electric motor and at least intermittently by muscle power. In particular, the invention relates generally to a propulsion device for a vehicle, in which drive power of an electric motor and drive power generated by muscle power can be combined and used to propel the vehicle. The vehicle can be in the form of an e-bike or a pedelec, in which the propulsion by muscle power can be assisted by the propulsion of the electric motor.

### BACKGROUND

From the prior art according to DE 10 2015 100 676 B3, a propulsion device for a bicycle or a pedelec is described. In this propulsion device, an electric motor is used to generate propulsive force for the vehicle. To do this, the electric motor is coupled to an output element of the propulsion device via a strain wave gear.

From the prior art according to EP 2 976 551 B1, a pin ring gearing is described, which is a design of a strain wave gear, with which a predetermined transmission ratio can be provided for transmitting a propulsive force.

### BRIEF SUMMARY

In example aspects, a propulsion device for a vehicle includes the following: an electric motor for at least intermittently propelling the vehicle by supplying electrical power to the electric motor; a crank axle for receiving muscle power to at least intermittently propel the vehicle by muscle power; and an output element via which the propulsive force for propelling the vehicle can be given off from the propulsion device. The propulsion device also includes a gearing having a predetermined transmission ratio, which gearing is coupled on the input side to an output element of the electric motor and can be coupled on the output side to the output element of the propulsion device via a gearing output element. In addition, the propulsion device includes a crank axle output element which is coupled to the crank axle and can be coupled to the output element of the propulsion device. The propulsion device includes a torque limiting assembly which is designed to limit a torque acting in the power transmission path between the electric motor and the output element.

The propulsion device can be fixedly mounted on the vehicle. The propulsion device can be in the form of an assembly and mountable on the vehicle such that a compact design is made possible. The vehicle can be intended for transporting persons. In addition, the vehicle can be intended for transporting goods. The vehicle can be in the form of a single-track vehicle. Alternatively, the vehicle can be in the form of a multi-track vehicle. The vehicle can be in the form of an e-bike or a pedelec, in which muscle power as well as the propulsive force of an electric drive can be used to propel the vehicle. An electrical energy store device can be provided, with which the electric motor of the propulsion device can be operated. Furthermore, a control device can be provided, with which the operation of the electric motor can be controlled by an open-loop system. The vehicle can have pedals which are mounted on the crank axle to enable the introduction of muscle power.

According to one example embodiment, the gearing can include a support element which is coupled to a housing of the propulsion device for counteracting a reaction torque, wherein the torque limiting assembly can be provided in the power transmission path between the support element and the housing in order to limit the support torque to a predetermined maximum support torque.

According to one example embodiment, if the predetermined maximum support torque is exceeded, the torque limiting assembly can permit a rotation of the support element of the gearing relative to the housing, such that the torque acting on the rotor of the electric motor due to reaction torque can be limited to a permissible torque.

According to one example embodiment, the torque limiting assembly can be provided in the power transmission path between the output element of the electric motor and an input side of the gearing in order to limit the torque transmitted via the power transmission path between the output element of the electric motor and the input side of the gearing to a predetermined maximum torque.

According to one example embodiment, if the predetermined maximum torque is exceeded, the torque limiting assembly can permit a rotation of the output element of the electric motor relative to the input side of the gearing, such that the torque acting on the rotor of the electric motor can be limited to a permissible torque.

According to one example embodiment, the torque limiting assembly can be provided in the power transmission path between the gearing output element and the output element of the propulsion device in order to limit the torque transmitted via the power transmission path between the gearing output element and the output element of the propulsion device to a predetermined maximum torque.

According to one example embodiment, if the predetermined maximum torque is exceeded, the torque limiting assembly can permit a rotation of the gearing output element relative to the output element, such that the torque acting on the rotor of the electric motor can be limited to a permissible torque.

The torque acting on the rotor of the electric motor can result from the drive of the electric motor and the transmission function of the gearing. In this case, the torque acting on the rotor of the electric motor corresponds to the present drive torque of the electric motor. The torque acting on the rotor of the electric motor can additionally or alternatively result from an action on the gearing. In particular, if there is action on the output side of the gearing, at least a portion thereof is transmitted onto the rotor of the electric motor via the gearing.

Additionally or alternatively, torque shocks that act on the output side of the gearing can be transmitted onto the rotor of the electric motor via the gearing.

Furthermore, the torque acting on the rotor of the electric motor can result from the dynamic mode of operation of the propulsion device. In particular, the torque acting on the rotor of the electric motor can result from a dynamic mode of operation in conjunction with a moment of inertia of the participating moving elements. The torque on the rotor of the electric motor can be subjected to strong fluctuations when there are sharp changes in rotational speed at the electric motor or fluctuations in rotational speed are induced on the output side of the gearing.

According to one example embodiment, the torque limiting assembly can include a friction clutch arrangement which is preloaded by a preloading element such that, if a predetermined maximum torque applied at the torque limiting assembly is exceeded, a slip is induced in the friction clutch arrangement, such that a relative motion between an input side and an output side of the torque limiting assembly is permitted by the torque limiting assembly. The friction clutch arrangement can be formed from one or multiple friction clutch plates. Alternatively, the friction clutch arrangement can be formed from one or cone elements. The friction clutch arrangement can be axially symmetrical to an axis of symmetry of the propulsion device.

According to one example embodiment, the torque limiting assembly can include an interlocking clutch arrangement having a detent body and a detent body receptacle, which are preloaded onto each other by a preloading element to form an interlocking connection such that, if a predetermined maximum torque applied at the torque limiting assembly is exceeded, the detent body is released from the detent body receptacle, such that a relative motion between an input side and an output side of the torque limiting assembly is permitted by the torque limiting assembly. The detent body can be in the form of a ball. The detent body receptacle can be in the form of a body having an indentation which is designed to accommodate the detent body. When the detent body is in the form of a ball, it is particularly advantageous when the detent body receptacle is a circular indentation or a spherical indentation. The interlocking clutch assembly can be axially symmetrical to an axis of symmetry of the propulsion device. The interlocking clutch assembly can have a multitude of detent elements and, correspondingly, a multitude of detent body receptacles associated with the detent elements.

According to one example embodiment, the gearing can be in the form of a strain wave gear. When the gearing is in the form of a strain wave gear, this can include an inner bush which is provided with external toothing and is coupled to a gearing output element, an outer ring which is provided with internal toothing and is a support element of the gearing, and a bush bearing which can be driven by the electric motor via an input side of the gearing for the peripheral deformation of the inner bush. The external toothing of the inner bush can have a lower number of teeth than the internal toothing of the outer ring and the peripheral deformation of the inner bush can bring about a rotation of the inner bush relative to the outer ring.

According to one example embodiment, the gearing can be in the form of a planetary gear set. When the gearing is in the form of a planetary gear set, this can include a sun gear, a ring gear, and a planet carrier which carries at least one planet gear meshing with the sun gear and the ring gear. The sun gear, the ring gear, and the planet carrier can form a support element which is coupled to a housing of the propulsion device for supporting a reaction torque, an input side of the gearing, and a gearing output element. The planetary gear set in one example embodiment can be designed such that the sun gear forms an input side of the gearing, the planet carrier forms the gearing output element, while the ring gear forms the support element which is coupled to the housing of the propulsion device for supporting the reaction torque. Alternatively, the support element can be formed by the sun gear or by the planet carrier. The gearing can have more than one planetary gear set, which planetary gear sets are coupled to one another. Furthermore, the gearing can be in the form of a stepped planetary gear set.

According to one example embodiment, the gearing can be in the form of a spur gear stage. When the gearing is in the form of a spur gear stage, this includes at least two spur gears which mesh with one another and are supported via a support arrangement. One of the spur gears forms an input side of the gearing, the other of the spur gears forms a gearing output element, and the support arrangement forms a support element of the gearing. The gearing can have more than one spur gear stage. When more than two spur gears are provided, one of the spur gears forms the input side of the gearing and another of the spur gears, via which the propulsive force of the gearing is output, forms the gearing output element. For this case as well, the support arrangement of the spur gears forms the support element of the gearing.

According to one example embodiment, the output element can be coupled to an output gear which drives at least one driven wheel of the vehicle via a traction mechanism. A gear change mechanism can be provided between the output gear and the at least one driven wheel of the vehicle, which gear change mechanism is designed to change the transmission ratio between the output gear and the at least one driven wheel in a stepped manner.

The traction mechanism can be a chain which is guided via an arrangement of sprockets or chainrings. When the traction mechanism is in the form of a chain, the gear change mechanism can be in the form of a derailleur system. The gear change mechanism, which is in the form of a derailleur system, can be provided with adjusting devices which guide the traction mechanism, which is in the form of a chain, on gear wheels having various numbers of teeth. In particular, the derailleur system can have a multitude of sprockets at the driven wheel, which sprockets have various numbers of teeth. Additionally or alternatively, the derailleur system can have a multitude of chainrings at the crank axle region, which chainrings have different numbers of teeth. By guiding the chain onto a predetermined combination of sprockets or chainrings, the transmission ratio between the output gear of the propulsion device and the driven wheel of the vehicle can be discretely adjusted.

Alternatively, the gear change mechanism can be in the form of a hub gear on the driven wheel of the vehicle. In this case, a gear wheel gearing arrangement can be provided in the region of a hub of the driven wheel of the vehicle, with which gear wheel gearing arrangement the transmission ratio between the driven wheel and a drive element connected to the hub gear is discretely variable. In this case, the traction mechanism can be a chain. Alternatively, the traction mechanism can be a belt, including a toothed belt.

According to one example embodiment, a freewheel unit can be provided in the power transmission path between the gearing output element and the output element. The freewheel unit between the gearing output element and the output element can be designed such that power can be transmitted from the gearing output element to the output element for propelling the vehicle in the forward direction.

According to a further example embodiment, a freewheel unit can be provided in the power transmission path between the crank axle output element and the output element. The freewheel unit between the crank axle output element and the output element can be designed such that power can be transmitted from the crank axle output element to the output element for propelling the vehicle in the forward direction.

The vehicle in the aforementioned embodiments can be in the form of an e-bike or a pedelec. In particular, the vehicle can be in the form of a single-track vehicle having a front wheel and a rear wheel. The driven wheel of the vehicle can be the rear wheel. The propulsion device can be mounted on a frame of the vehicle. The vehicle can also have an electrical energy store device which can be provided for supplying electrical energy to the propulsion device. The vehicle can also include a control element with which the rider can actuate the gear change mechanism.

### BRIEF DESCRIPTION OF THE FIGURES

FIG. 1 shows a schematic view of an example embodiment of the propulsion device; and FIG. 2 shows a schematic view of a modified example embodiment of the propulsion device.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

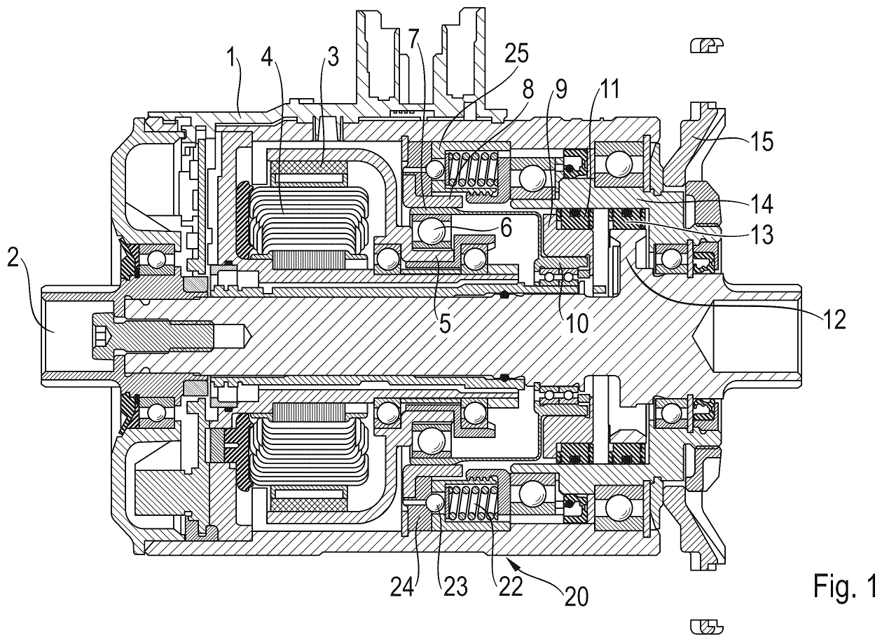

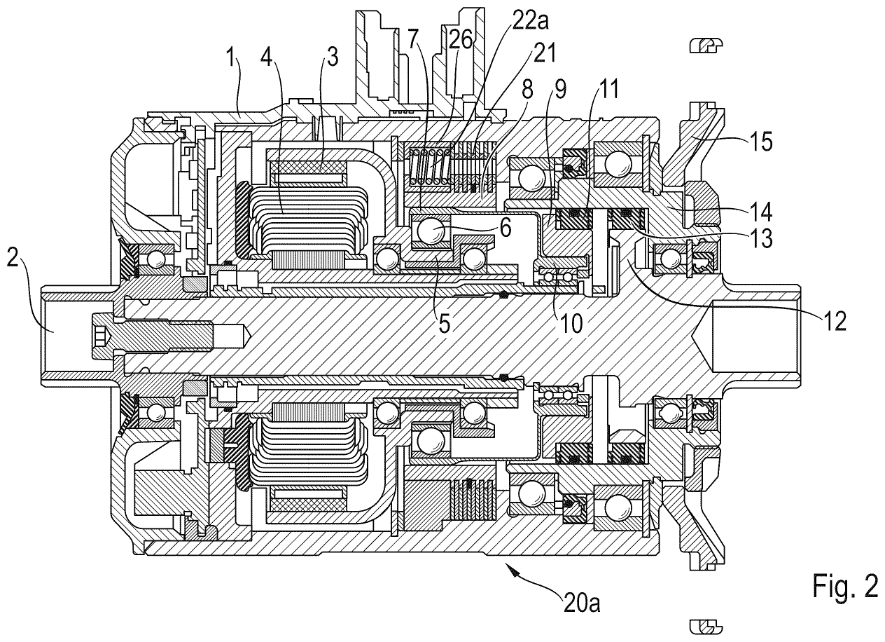

Example embodiments are described in the following with reference to the drawings. FIG. 1 shows a schematic view of an example embodiment of the propulsion device for a vehicle. In the view shown in FIG. 1, the propulsion device is shown in a cutaway view along an axis of symmetry. The propulsion device shown in FIG. 1 has a housing 1 which forms an outer circumference of the propulsion device. Mounts are provided on the housing 1, and the mounts are designed to mount the propulsion device on a vehicle.

The housing 1 accommodates a crank axle 2 which extends in the axial direction through the housing 1 and, at both axial ends thereof, projects out of the housing 1. The crank axle 2 is rotatably mounted within the housing 1. Pedal cranks (not shown in FIG. 1) are mounted on the crank axle 2, which pedal cranks are designed to introduce muscle power into the crank axle 2.

The crank axle 2 has a crank axle output element 12 which is provided as a radial shoulder on the crank axle 2 in the present example embodiment. On the outer circumference of the crank axle output element 12 there is a first freewheel unit 13 with which the crank axle output element 12 can be coupled to the output element 14 of the propulsion device. The output element 14 in the present example embodiment is in the form of a sleeve-shaped element, on the inner circumference of which the first freewheel unit 13 is provided.

The output element 14 is rotatably mounted within the housing 1 and projects axially out of the housing, as shown in FIG. 1. An output gear 15 in the form of a gear wheel is provided on the output element 14. A rotation of the output element 14 therefore brings about a rotation of the output gear 15 which is fixedly connected to the output element 14.

When the crank axle 2 is rotated in a first direction which is associated with a forward direction of the vehicle, the first freewheel unit 13 transmits the rotation of the crank axle output element 12 onto the output element 14. Therefore, the output gear 15 rotates in this case due to the rotation of the crank axle 2 in the direction associated with the forward travel of the vehicle. When the crank axle 2 rotates in the opposite direction relative to the output element 14, the first freewheel unit 13 disengages and the rotation of the crank axle 2 is not transmitted onto the output gear 15.

On the left side in FIG. 1, an electric motor is provided in a corresponding hollow space in the housing 1. The electric motor has a stator 4 which is mounted stationarily with respect to the housing. The electric motor also has a rotor 3 which is located radially outside the stator 4 and is rotatably supported on the housing 1 via a corresponding mounting. The motor having the internal stator 4 and the external rotor 3 is therefore designed as an external-rotor machine. A control device is provided in the region located to the left of the electric motor in FIG. 1, which control device is used to energize the stator 4 of the electric motor from an external energy source. When the stator 4 is energized, the winding of the stator 4 is excited and a rotation of the rotor 3 of the electric motor is induced. This rotation of the rotor 3 of the electric motor is transmitted onto the output element 5 of the electric motor.

A gearing is provided on the right side of the electric motor in FIG. 1. The gearing shown in FIG. 1 is in the form of a strain wave gear in the present example embodiment. The strain wave gear includes an inner bush 7, on the outer side of which teeth are provided. The inner bush 7 is in the form of a sleeve which is flexible in the circumferential direction. An outer ring 8 is located outside of the inner bush 7. The outer ring 8 has internal toothing which can selectively engage with the external toothing of the inner bush 7. A bush bearing 6 is provided within the inner bush 7 in the present example embodiment. The bush bearing 6 has an outer ring which has a non-circular shape. In particular, the outer ring of the bush bearing 6 is elliptical. The inner ring of the bush bearing 6 is coupled to the output element 5 of the electric motor.

When the rotor 3 of the electric motor rotates, the bush bearing 6 is set into rotation. Due to the non-circular shape of the outer ring of the bush bearing 6 and the placement thereof against an inner circumference of the inner bush 7, the inner bush 7 is peripherally deformed. As a design which is characteristic for a strain wave gear, the inner bush 7 has a number of teeth which is lower than the number of teeth of the internal toothing of the outer ring 8. Therefore, when the outer ring 8 is fixed and the bush bearing 6 rotates, the inner bush 7 is set into rotation. The direction of rotation of the inner bush 7 runs counter to the direction of rotation of the rotor 3 of the electric motor.

Due to the particular design of the strain wave gear, high transmission ratios of 1:50 or more can be achieved in combination with compact designs. In the present application, an electric motor can therefore be used, which has a compact design due to the relatively high nominal rotational speeds. In particular, electric motors can be used, which have a nominal rotational speed of five thousand rotations per minute (5000 rpm) or higher. The reduced rotational speed due to the transmission ratio of the gearing is transmitted to a support element 10 of the strain wave gear which is rotatably supported on the housing 1 via mountings.

A gearing output element 9 is coupled to the support element 10 of the strain wave gear. The rotation of the support element 10 is transmitted to the gearing output element 9 which is located radially outside the support element 10 of the strain wave gear. A second freewheel unit 11 is provided on the radially outer circumference of the gearing output element 9. The second freewheel unit 11 is located between the radial outer circumferential surface of the gearing output element 9 and the radial inner circumferential surface of the output element 14 of the propulsion unit. The second freewheel unit 11 is designed such that the transmits a rotation of the gearing output element 9 to the output element 14, which gearing output element is associated with forward travel of the vehicle. A rotation of the gearing output element 9 relative to the output element 14 in a direction of rotation which runs counter to the direction of rotation associated with forward travel is not transmitted to the output element 14.

Therefore, the rotations of the crank axle 2 and of the gearing output element 9 are combined at the output element 14. In this way, the propulsion device has a function of combining the muscle power introduced into the crank axle 2 and the propulsive force output by the rotor 3 of the electric motor.

In the present example embodiment, the output gear 15 is in the form of a chainring of a bicycle drive. The output gear 15, which is in the form of a chainring, carries a chain (not shown) as a traction mechanism which is provided with a cassette (not shown) on a hub of a rear wheel of the vehicle. In one example embodiment, the vehicle has a derailleur system which can guide the chain onto sprockets having various numbers of teeth by means of a shifting mechanism. The shifting mechanism is actuated by the rider via a control element in the present embodiment.

During operation of the vehicle, the rider can introduce muscle power into the propulsion device via the crank axle 2, which muscle power is transmitted to the output element 14 via the first freewheel unit 13. Simultaneously or at least intermittently, the propulsive force of the electric motor can also be transmitted to the output element 14 via the gearing shown in FIG. 1 and via the second freewheel unit 11. In such an operating state, when the rider actuates the control element to change the position of the chain in order to change the transmission ratio between the output gear 15, which is in the form of a chainring, and the rear wheel, dynamic changes in rotational speed occur and shocks are caused due to the inertia of the weighted elements. Furthermore, during operation of the vehicle, for example, during a brake application or while riding on extremely uneven ground, strong fluctuations and shocks occur in the drive train between the output gear 15 and the rear wheel of the vehicle.

In order to take these relationships into account, the propulsion device includes a torque limiting assembly 20 which is shown in FIG. 1. The torque limiting assembly 20 has a detent body 23 in the form of a ball in the example embodiment shown in FIG. 1. As shown in FIG. 1, the detent body 23 is preloaded by a preloading element 22 in FIG. 1 to the left towards a detent body receptacle 24. The detent body receptacle 24 has an indentation which is designed to partially accommodate the detent body 23.

In the torque limiting assembly 20 shown in FIG. 1, the detent body receptacle 24 is concentrically designed and is mounted, radially outside the outer ring 8 of the strain wave gear, on the outer ring. On the other side, the detent body 23 is provided with the preloading element 22 in a holder 25 which is provided concentrically on the inner circumference of the housing 1 and is mounted thereon. In the state shown in FIG. 1, the detent body 23, which is in the form of a ball, projects into the indentation of the detent body receptacle 24 and is preloaded against the detent body receptacle 24 by the preloading element 22 which is in the form of a spring. In this state, an interlocking connection is established between the detent body receptacle 24 and the holder 25, such that the outer ring 8 remains stationary with respect to the housing 1.

For the case in which a relative torque occurs between the detent body receptacle 24 and the holder 25 during operation of the propulsion device, which relative torque is so great that the detent body 23 moves out of the detent body receptacle 24 counter to the preload force of the preloading element 22, a relative rotation between the detent body receptacle 24 and the holder 25 is made possible. In this situation, the outer ring 8 can rotate relative to the housing 1. Therefore, for the case in which the support torque which acts on the outer ring 8 exceeds a maximum torque, the torque acting on the rotor 3 of the electric motor can be limited. For this purpose, the torque limiting assembly 20 and, in particular, the spring force of the preloading element 22, is designed according to the specifications for protecting the electric motor.

The present example embodiment can therefore ensure that excessive torque fluctuations, shocks, and the transmission of strong torques due to the inertia of the overall system are transmitted onto the rotor of the electric motor only up to a maximum design specification. Therefore, the function and the durability of the electric motor can be improved.

In the following, another example embodiment of the propulsion device is described with reference to FIG. 2. The elements of the propulsion device shown in FIG. 2 generally correspond to those shown in FIG. 1 and only the differences are described in the following. Whereas the propulsion device shown in FIG. 1 includes a torque limiting assembly 20 which has the detent body 23, the detent body receptacle 24, and the holder 25, in the example embodiment shown in FIG. 2, a torque limiting assembly 20a is provided at the equivalent position, which torque limiting assembly has a friction clutch arrangement 21, a preloading element 22a, and a holder 26. In a manner similar to that in the example embodiment shown in FIG. 1, in the example embodiment shown in FIG. 2, the outer ring 8 is held stationarily on the housing 1 via the torque limiting assembly 20a.

The torque limiting assembly 20a shown in FIG. 2 has the spring 22a which is accommodated in a holder 26. The holder 26 is mounted on the inner circumference of the housing 1. On the other side, the friction clutch arrangement 21 is provided on the outer circumference of the outer ring 8, which friction clutch arrangement includes multiple friction clutch elements which are arranged concentrically about the outer circumference of the outer ring 8.

The friction clutch elements have stationary friction clutch elements which are non-rotatably mounted on the housing 1, and movable friction clutch elements which are mounted on the outer circumference of the outer ring 8. The stationary friction clutch elements and the movable friction clutch elements are stacked on top of one another in alternation. Due to the spring force of the preloading element 22a, the stationary friction clutch elements and the movable friction clutch elements of the friction clutch arrangement 21 are compressed, such that the outer ring 8 remains stationary with respect to the housing up to a certain torque. If the maximum torque according to the design specification is exceeded, a slip is generated at the friction clutch arrangement 21, such that the stationary friction clutch elements and the movable friction clutch elements of the friction clutch arrangement 21 can rotate relative to each other and, thus, the outer ring 8 can rotate relative to the housing 1.

Therefore, in a manner which is similar to that in the example embodiment shown in FIG. 1, in the example embodiment shown in FIG. 2, if a maximum support torque is exceeded, the outer ring 8 can rotate relative to the housing 1. This function ensures that the maximum torque acting on the rotor 3 of the electric motor can be limited.

In further example embodiments, the above-described types of torque limiting assemblies 20, 20a can be used, although the torque limiting assemblies 20, 20a are provided at other positions in the propulsion device.

In an alternative example embodiment (not shown in the figures), the torque limiting assembly 20, 20a is integrated into the output element 5 of the electric motor. As a result, if a maximum torque according to the design specification acting on the torque limiting assembly is exceeded, a relative rotation between the output element 5 of the electric motor and the input side of the gearing is brought about. With this design, the maximum torque acting on the rotor 3 of the electric motor can be limited.

In an alternative example embodiment (not shown in the figures), the torque limiting assembly 20, 20a is integrated into the gearing output element 9. In particular, by providing the torque limiting assembly 20, 20a at the gearing output element 9, if a maximum torque according to the design specification acting on the torque limiting assembly is exceeded, a relative rotation between the gearing output element 9 and the output element 14 of the propulsion device is brought about. With this design, the maximum torque acting on the rotor 3 of the electric motor can be limited.

In an alternative example embodiment (not shown), the gearing is in the form of a planetary gear set. In a further alternative embodiment (not shown), the gearing is in the form of a spur gear stage. Other gearing designs are conceivable, provided the gearing is supported against the housing of the propulsion device with a support element and the gearing, similarly to the above-described strain wave gear, has an input side, which is coupled to the rotor of the electric motor, and a gearing output element which can be coupled to the output element of the propulsion device.

In the present example embodiments, the propulsion device is used on a bicycle which is in the form of an e-bike or a pedelec. In alternative example embodiments, the propulsion device is used on a multi-track vehicle, in particular on a vehicle having three or four wheels.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### Reference Characters

1 housing
2 crank axle
3 rotor of electric motor
4 stator of electric motor
5 output element of electric motor
6 bush bearing of strain wave gear
7 inner bush of strain wave gear
8 outer ring of strain wave gear
9 gearing output element
10 support element of strain wave gear
11 second freewheel unit
12 crank axle output element
13 first freewheel unit
14 output element
15 output gear
20, 20a torque limiting assembly
21 friction clutch arrangement
22, 22a preloading element
23 detent body
24 detent body receptacle
25 holder
26 holder

1-15. (canceled)

16. A propulsion device for a vehicle, comprising:
an electric motor (3, 4) configured for at least intermittently propelling the vehicle by supplying electrical power to the electric motor (3, 4);
a crank axle (2) configured for receiving muscle power to at least intermittently propel the vehicle by muscle power;
an output element (14) via which propulsive force for propelling the vehicle is output from the propulsion device;
a gearing having a predetermined transmission ratio, the gearing coupled on an input side to an output element (5) of the electric motor (3, 4), the gearing couplable on an output side to the output element (14) of the propulsion device via a gearing output element (9);
a crank axle output element (12) coupled to the crank axle (2), the crank axle output element (12) couplable to the output element (14) of the propulsion device; and
a torque limiting assembly (20; 20a) configured to limit a torque acting in a power transmission path between the electric motor (3, 4) and the output element (14).

17. The propulsion device of claim 16, wherein the gearing comprises a support element coupled to a housing (1) of the propulsion device for counteracting a reaction torque, the torque limiting assembly (20; 20a) disposed in a power transmission path between the support element and the housing (1) in order to limit the support torque to a predetermined maximum support torque.

18. The propulsion device of claim 17, wherein, when the predetermined maximum support torque is exceeded, the torque limiting assembly (20; 20a) permits rotation of the support element of the gearing relative to the housing such that the torque acting on the rotor (3) of the electric motor (3, 4) due to reaction torque is limited to a permissible torque.

19. The propulsion device of claim 16, wherein the torque limiting assembly (20; 20a) is disposed in a power transmission path between the output element (5) of the electric motor (3, 4) and an input side of the gearing in order to limit the torque transmitted via the power transmission path between the output element (5) of the electric motor (3, 4) and the input side of the gearing to a predetermined maximum torque.

20. The propulsion device of claim 19, wherein, when the predetermined maximum support torque is exceeded, the torque limiting assembly (20; 20a) permits rotation of the output element (5) of the electric motor (3, 4) relative to the input side of the gearing such that the torque acting on the rotor (3) of the electric motor (3, 4) is limited to a permissible torque.

21. The propulsion device of claim 16, wherein the torque limiting assembly (20; 20a) is disposed in a power transmission path between the gearing output element (9) and the output element (14) of the propulsion device in order to limit the torque transmitted via the power transmission path between the gearing output element (9) and the output element (14) of the propulsion device to a predetermined maximum torque.

22. The propulsion device of claim 21, wherein, when the predetermined maximum support torque is exceeded, the torque limiting assembly (20; 20a) permits rotation of the gearing output element (9) relative to the output element (14), such that the torque acting on the rotor (3) of the electric motor (3, 4) is limited to a permissible torque.

23. The propulsion device of claim 16, wherein the torque limiting assembly (20a) comprises a friction clutch arrangement (21) that is preloaded by a preloading element (22a) such that, when a predetermined maximum torque applied at the torque limiting assembly (20a) is exceeded, a slip is induced in the friction clutch arrangement (21) such that relative motion between an input side and an output side of the torque limiting assembly (20a) is permitted by the torque limiting assembly (20a).

24. The propulsion device of claim 16, wherein the torque limiting assembly (20) comprises a detent body (23) and a detent body receptacle (24) that are preloaded onto each other by a preloading element (22) to form an interlocking connection such that, when a predetermined maximum torque applied at the torque limiting assembly (20) is exceeded, the detent body (23) is released from the detent body receptacle (24) such that relative motion between an input side and an output side of the torque limiting assembly (20) is permitted by the torque limiting assembly (20).

25. The propulsion device of claim 16, wherein:
the gearing comprises a strain wave gear that includes an inner bush (7) with external toothing and coupled to a gearing output element (9), the strain wave gear also includes an outer ring (8) with internal toothing and configured as a support element of the gearing, the strain wave gear further including a bush bearing (6) drivable by the electric motor (3, 4) via an input side of the gearing for peripheral deformation of the inner bush (7);
the external toothing of the inner bush (7) has fewer teeth than the internal toothing of the outer ring (8); and
the strain wave gear is configured such that the peripheral deformation of the inner bush (7) drives rotation of the inner bush (7) relative to the outer ring (8).

26. The propulsion device of claim 16, wherein:
the gearing comprises a planetary gear set with a sun gear, a ring gear, and a planet carrier that carries at least one planet gear meshing with the sun gear and the ring gear;
the sun gear, the ring gear, and the planet carrier forming a support element coupled to a housing (1) of the propulsion device for supporting a reaction torque, an input side of the gearing, and a gearing output element.

27. The propulsion device of claim 16, wherein:
the gearing comprises a spur gear stage with at least two spur gears meshed with one another and supported via a support arrangement;
one of the spur gears forming an input side of the gearing, and another of the spur gears forming a gearing output element;
the support arrangement forming a support element of the gearing.

28. The propulsion device of claim 16, wherein:
the output element (14) is coupled to the output gear (15) configured to drive at least one driven wheel of the vehicle via a traction mechanism;
a gear change mechanism is disposed between the output gear (15) and the at least one driven wheel of the vehicle; and
the gear change mechanism is configured to change the transmission ratio between the output gear (15) and the at least one driven wheel in a stepped manner.

29. The propulsion device of claim 16, wherein a freewheel unit (11) is disposed in a power transmission path between the gearing output element (9) and the output element (14).

30. The propulsion device of claim 16, wherein a freewheel unit (13) is disposed in a power transmission path between the crank axle output element (12) and the output element (14).
